(19) United States
(12) Patent Application Publication
(10) Pub. No.: US 2018/0264437 A1
(43) Pub. Date: Sep. 20, 2018

(54) ADSORBENT MIXTURE HAVING IMPROVED THERMAL CAPACITY

(71) Applicant: l'Air Liquide, Société Anonyme pour I'Etude et I'Exploitation des procédés Georges Claude, Paris (FR)

(72) Inventors: Patrick LE BOT, Vincennes (FR); Christian MONEREAU, Montpellier (FR); Pluton PULLUMBI, Versailles (FR); Guillaumje RODGRIGUES, Le Plessis Trevise (FR)

(21) Appl. No.: 15/534,908

(22) PCT Filed: Nov. 25, 2015
(86) PCT No.: PCT/FR2015/053210

§ 371 Date: Jun. 9, 2017

(30) Foreign Application Priority Data
Dec. 11, 2014 (FR) 1462222

(51) Int. Cl. B01J 20/28; B01D 53/04; B01D 53/047

(52) U.S. Cl. CPC B01J 20/28004; B01J 20/2803; B01D 2253/1124; B01D 53/047; B01D 2253/102; B01D 53/0423

(57) ABSTRACT

A composite adsorbent mixture is provided, including at least one adsorbent active principle in the form of microparticles and a non-adsorbent thermal principle in the form of microparticles, where the characteristic mean size Di of the microparticles of the thermal principle is smaller than the characteristic mean size Da of the microparticles of the active principle.

### CROSS REFERENCE TO RELATED APPLICATIONS

This application is a 371 of International PCT Application PCT/FR2015/053210 filed Nov. 25, 2015 which claims priority to French Patent Application No. 1462222 filed Dec. 11, 2014, the entire contents of which are incorporated herein by reference.

### BACKGROUND

The invention relates to a composite adsorbent mixture intended essentially for the separation or purification of gases by means of the P.S.A. process, to the process for producing same, to the adsorbents obtained after forming of said mixture, to the adsorbers using such adsorbents and to the adsorption units comprising these adsorbers.

The invention relates more particularly to a means of reducing the thermal effects undergone by a thermocyclic adsorption process with a short phase time, typically less than 30 seconds, so as to thus improve the performance levels thereof.

The term “thermocyclic adsorption process” is used to refer to any cyclic process during which certain steps are exothermic, that is to say which are accompanied by a release of heat, while certain other steps are endothermic, that is to say are accompanied by heat consumption. This is in particular the case with gas separation processes by means of pressure-modulated adsorption, such as PSA (pressure swing adsorption), VSA (vacuum swing adsorption), VPSA (vacuum pressure swing adsorption) and MPSA (mixed pressure swing adsorption).

In the context of the present invention, the term “PSA process” denotes, unless otherwise stipulated, any gas separation process by means of pressure-modulated adsorption, using a cyclic variation of the pressure between a high pressure, termed adsorption pressure, and a low pressure, termed regeneration pressure. Consequently, the generic name PSA process is employed without distinction to denote all the cyclic processes mentioned above, the respective operating conditions of which processes are specified below:

VSA processes in which the adsorption is carried out substantially at atmospheric pressure, termed “high pressure”, that is to say between 1 bara and 1.6 bara (bara=bar absolute), preferentially between 1.1 and 1.5 bara, and the desorption pressure, termed “low pressure”, is below atmospheric pressure, typically between 30 and 800 mbara, preferably between 100 and 600 mbara;

the VPSA or MPSA processes in which the adsorption is carried out at a high pressure substantially above atmospheric pressure, generally between 1.6 and 8 bara, preferentially between 2 and 6 bara, and the low pressure is below atmospheric pressure, typically between 30 and 800 mbara, preferably between 100 and 600 mbara;

the PSA processes in which the adsorption is carried out at a high pressure very much above atmospheric pressure, typically between 1.6 and 50 bara, preferentially between 2 and 35 bara, and the low pressure is above or substantially equal to atmospheric pressure, thus between 1 and 9 bara, preferably between 1.2 and 2.5 bara.

In general, a PSA process makes it possible to separate one or more molecules of gas from a gas mixture containing them, by exploiting the difference in affinity of an adsorbent (or, where appropriate, of several adsorbents) toward these various molecules of gas.

The affinity of an adsorbent for a gas molecule depends on the structure and on the composition of the adsorbent, and also on the properties of the molecule, in particular its size, its electron structure and its multipolar moments.

An adsorbent can be for example a zeolite, an activated carbon, an activated alumina, a silica gel, a resin, a carbonated or non-carbonated molecular sieve, a metalorganic structure, one or more alkali metal or alkaline-earth metal oxides or hydroxides, or a porous structure containing a substance capable of reversibly reacting with one or more molecules of gas, such as amines, physical solvents, metal complexing agents, or metal oxides or hydroxides for example.

To date, thousands of industrial PSAs have been carried out for various applications and, since the beginning, numerous improvements have already been made to these units, whether it be in terms of ease of use, of reliability or of performance levels. Thus, with regard to improving performance levels, namely in particular the yield or the productivity, various approaches have been carried out, in particular:

Addition of equipment making it possible to regenerate the adsorbent at lower pressure, for instance a vacuum pump or an ejector, or for carrying out recycling of a part of the gas, for instance the addition of a compressor for recycling a part of the residual gas.

Choice of adsorbents which are more efficient, a larger number of adsorbents and as a result adsorbents that are more suitable to the change in the compositions actually within the adsorber, implemented in the form of successive multiple beds.

Use of a plurality of adsorbers allowing more effective cycles by addition of further steps, by different arrangement of the steps, etc.

In the context of the invention, there is interest in two other approaches also known to allow considerable gains both in terms of investment (increase in productivity for example) and in performance levels (increase in extraction yield, decrease in energy consumption, etc.):

shortening of the cycle time by even going toward RPSA (rapid PSA) or URPSA (ultra rapid PSA) processes which correspond to PSA processes with a very short cycle, generally less than one minute, or even about a few seconds for the latter cited;

control of the thermal effects during the adsorption and the regeneration.

The shortening of the phase time makes it possible, in theory, to maintain the performance levels while at the same time reducing the amount of adsorbent to be used starting from the moment when the mass kinetics are sufficient.

The adsorbent used is generally in the form of particles with which an adsorber is filled. These particles can be in the form of granules, rods, balls, or crushed materials. The characteristic dimensions of these particles generally range from 0.5 mm to 5 mm.

Using smaller particles makes it possible, in a large majority of PSA units, to improve the adsorption kinetics, that is to say to accelerate the transfer of material and thereby to be able to reduce the phase time and finally the volume of adsorbent to be used. In return, they create greater pressure drops on the fluid phase and to counteract this effect, use is made for example of adsorbers which have a large cross section for fluid passage, such as cylindrical adsorbers with a horizontal axis or radial adsorbers.

Another recommended solution in the search to increase the kinetics in the transfer of material has led to the use of particles for which the active ingredient has been deposited around a central core. Thus it is possible to have small thicknesses of adsorbent while at the same time retaining particles, generally balls, with a significant diameter and in this way continuing to use conventional adsorbers, etc. To illustrate this process, reference may be made in particular to document FR 2 794 993.

However, when it is desired to go further in improving the pressure drop and/or the kinetics, this technology leads to non-industrial adsorber geometries.

This is for example the case when it is desired to treat large gas flows at low pressure, for instance for the capture of CO₂ in effluents at atmospheric pressure or when it is desired to perform very rapid cycles, in particular the RPSA or URPSA cycles mentioned above.

As early as 1996, Ruthven and Thaeron—in Gas Sep. Purif. Vol. 10, p. 63—show that such an improvement can be obtained by using structured adsorbents and more particularly parallel-passage contactors.

These are systems with a more complex geometry which offer greater or easier passage to the fluid. As opposed to particulate adsorbents, (balls, rods, crushed materials) less than one cm in size, which are deposited in bulk in an adsorber, the fluid then circulating around the particles, structured adsorbents are solid materials of which the size ranges from a few centimeters to a few meters and which present free passages to the gas. This type of forming of adsorbent is in particular described in document F. Rezaei, P. Webley/Separation and Purification Technology 0(2010) 243-256.

Structured adsorbents (in comparison with granulated adsorbents) have the particularity of allowing very good kinetics and very low pressure drops without exhibiting any known attrition limit. There are many patents or publications on this subject, such as for example document FR 2952553, the figures of which present a certain number of possibilities for producing parallel-passage contactors. The term “parallel-passage contactors” is intended to mean a subgroup of structured adsorbents in which the fluid passes in channels, the walls of which contain adsorbent, which channels in this case are essentially free of obstacles and allow the liquid to circulate from an inlet to an outlet of the contactor. These channels can be rectilinear, directly connecting the inlet to the outlet of the contactor, or can exhibit several changes of direction. During its circulation, the fluid is in contact with at least one adsorbent present at the level of said walls. In this case, the adsorbent is generally deposited on a sheet-type support. The sheets can be folded, rolled up or stacked in order to create regular passages for the gas.

Adsorbent fibers installed for example in parallel can also constitute a contactor.

It is also possible to directly obtain, by extrusion, hollow geometric forms which then form systems comprising both adsorbent walls and passages for the fluid. This type of adsorber is commonly known as a monolith. The term bees nest geometry is then often used, even though the shape of the channels is not hexagonal but is square, rectangular, triangular, etc.

It can thus be retained that there are various means for improving the mass transfer of a PSA process and thus for efficiently going toward rapid cycles. The corresponding literature does not address the means for simultaneously providing thermal improvements to the PSA units that can implement these systems with improved mass kinetics.

The thermal effects, for their part, result from the adsorption enthalpy or from the reaction enthalpy and generally result in the propagation, at each cycle, of an adsorption heat wave limiting the adsorption capacities and of a desorption cold wave limiting the desorption.

This local cyclic phenomenon of temperature fluctuations has a not insignificant impact on the separation performance levels and the specific energy of separation as recalled by document EP-A-1188470 which discloses moreover means for reducing these temperature fluctuations by gradually mixing for example adsorbents with a high and low adsorption capacity or else, on the one hand, adsorbent and, on the other hand, particles of high heat capacity.

A specific case covered in the context of the present patent is the storing/withdrawing of gas in a reactor or adsorber containing at least in part one or more adsorbents. This is also a thermocyclic process using an adsorbent material with release of heat during storage (pressure increase) and release of cold during withdrawal (pressure decrease). In general, at least one of the storing or withdrawing steps is carried out rapidly and results in a temperature variation (heating or cooling) decreasing the useful capacity of the storage.

In all these cases, a solution which makes it possible to decrease the amplitude of the thermal fluctuations, or even to virtually totally eliminate them, consists in adding to the adsorbent bed a phase change material (PCM), as described in document U.S. Pat. No. 4,971,605 under the name T.A.R.M. (thermal absorption/release material). In this way, the adsorption and desorption heat, or a part of this heat, is adsorbed in the form of latent heat by the PCM, at the temperature, or in the temperature range, of the phase change of the PCM. It is then possible to operate the PSA unit in a mode closer to isothermal. Around ambient temperature, a hydrocarbon—or a mixture of hydrocarbons—can advantageously be used as PCM. When the temperature increases, the hydrocarbon contained in the ball absorbs heat and stores it. When the temperature decreases, the hydrocarbon contained in the ball releases the latent heat stored by changing phase, from liquid to solid. During the phase change period, the temperature remains approximately constant (depending on the composition of the wax) and makes it possible to regulate the temperature at levels clearly determined by the nature of the hydrocarbon (or of the hydrocarbons if it is a mixture) and in particular by the length of the chain and the number of carbon atoms.

For reasons of heat transfer through the phase change material itself, said material must generally be in the form of small particles, generally less than 100 microns. The term microparticle or microcapsule is subsequently used to denote this basic particle.

These microencapsulated PCMs cannot be introduced as they are into an adsorbent bed since it will be difficult to control the distribution thereof. In addition, they would be entrained by the streams of gas circulating in the adsorber.

Except for possibly in a very specific case, they cannot be directly integrated into the adsorbent since it is in fact known that the vast majority of adsorbents must be brought to high temperature before use in industrial processes in order to achieve the required performance levels in terms of mechanical strength and/or of adsorption. In the latter case, this is the step known as activation which consists, inter alia, in removing from the adsorbent the water molecules which preferentially occupy the most active sites and prevent—or limit—the adsorption of the other constituents. The temperature level required is generally above 200° C., often about from 300 to 450° C. These temperature levels are not compatible with the mechanical strength, or even the integrity, of PCMs. However, it can be conceived that, by means of a suitable forming process, microparticles of PCM are integrated with an active ingredient, the particle thus obtained being dried only at medium temperature and used in a process compatible with this treatment. A candidate could be an activated carbon formed with a low temperature binder, that is to say below 150° C. and preferentially around 100° C. Activation under a strong vacuum (less than 1 mbar) and/or by flushing with an ultra-dry gas (water content less than 1 ppm mol, preferentially less than 50 ppb mol) at a temperature of less than or equal to 100° C. can make it possible to activate a majority of adsorbent but at a high cost (energy, consumption of ultra-dry gas, activation time, etc.).

The solution retained industrially in the case of PCMs is thus to separately produce agglomerates of PCM, the size of which is of the order of magnitude of the particles of adsorbent, and to use them in a mixture with the latter, producing mixed beds of adsorbent/PCM in the required ratio. The advantages of this solution are that standard commercial adsorbents are used, and that it is possible to very significantly increase the heat capacity of the bed, making the process virtually isothermal. The drawbacks are the difficulty in ensuring the composition stability of the PCM agglomerate/particles of adsorbent mixture over time (filling, operating), the not very fast kinetics of the heat transfer with a characteristic length scale of the order of magnitude of the size of the particles and the non-suitability of this system as soon as only a limited increase in the heat capacity is sought. With PCM/adsorbent ratios of around one percent, there will now only be one particle of PCM surrounded by a large number of particles of adsorbent and the effects will be localized without it being possible to produce any real modification of the overall conditions of the thermal operation. The use of a mixed bed of adsorbent/agglomerated PCM particle will be very efficient as long as a virtually isothermal operation with thermal kinetics that are not too high is sought. As has been said, there nevertheless remain constraints in terms of respective dimensions, of respective densities, of mixing procedure, of filling procedure, and of operating conditions so that the mixed bed always has a homogeneous composition through the course of its use.

Following on from that, one problem which arises is that of providing an improved adsorbent material which reduces the thermal effects, this being particularly for units of which the adsorption and/or regeneration steps are rapid.

### SUMMARY

A solution of the present invention is a composite adsorbent mixture of at least one adsorbent active ingredient in the form of microparticles and a non-adsorbent thermal ingredient in the form of microparticles, characterized in that the characteristic mean size Di of the microparticles of the thermal ingredient is less than the characteristic mean size Da of the microparticles of the active ingredient.

Reference may also be made to inert thermal ingredient for the non-adsorbent thermal ingredient or even by simplification only “thermal ingredient”.

The term “microparticles of the thermal ingredient” is intended to mean particles of any shape, of characteristic size of at least one order of magnitude smaller than the size of the adsorbent material formed by all of the microparticles (for example a ball, a layer of adsorbent, etc.). According to one characteristic of the invention, the characteristic size of these microparticles will be less than approximately 100 microns, preferentially less than or equal to 25 microns and generally greater than 0.1 micron, preferentially greater than or equal to 0.5 micron.

The term “characteristic size” is intended to mean, for the isometric microparticles, that is to say microparticles which do not have a size clearly predominant in one particular direction and which are thus approximately spherical or cubic in shape, the common size that can be obtained by sieving, by visual observation or via image processing. For the particles, such as fibers or rods, having a predominant size that will be referred to as the length, the characteristic size will then be the thickness. This size is obtained by visual analysis or image processing.

For the adsorbent material formed from these particles, the characteristic size will in an identical manner be the diameter for balls, more generally the common size for isometric shapes, the diameter for rods or fibers, the thickness of the layer of adsorbent in the case of a deposit on a support, half the thickness in the case of an adsorbent wall in contact with the fluid via its two sides, etc. This size is not perfectly identical from one particle, or even from one system, to the other, but comprises a certain dispersion. The value retained here is the mean value as can be obtained for example via image processing software or via a series of measurements, etc. Without going into the details, for a population of isometric particles that can be likened, to a first approximation, to balls that are essentially spherical but the diameters of which have a dispersion inherent in the industrial manufacturing process, a conventional definition is retained: the equivalent or mean diameter Di of a population of balls is the diameter of identical balls that for the same bed volume would give the same total surface area. In fact, once the distribution in terms of diameter has been determined (that is to say the various fractions Xi of diameter di have been determined, with preferably i greater than or equal to 5 so as to obtain sufficient accuracy, for example by sieving or using image processing equipment), the equivalent mean diameter is obtained by the formula: 1/Di=Σi(Xi/di).

For particles that are more irregular, which is a form in which certain powders, for example of activated carbons, can in particular be found, the particles are nevertheless likened to spheres of which the distribution in terms of diameter is determined by sieving for example, then the above calculation formula is applied.

In practice, a particle of the adsorbent material according to the invention contains several hundred microparticles (active ingredient and thermal ingredient) and generally several thousand. In the case of a deposit, there will generally be more than ten microparticles in the thickness of the layer.

As appropriate, the adsorbent mixture according to the invention can have one or more of the characteristics below:

said mixture comprises a volume fraction X of thermal ingredient and a fraction (1-X) of active ingredient with X<0.5 and

$$Di < {( \frac{X}{1 - x} )}^{1 \text{/} 3} \times Da ;$$

the microparticles of the thermal ingredient are greater in number than the microparticles of the active ingredient;

the microparticles of the thermal ingredient have a characteristic mean size of between 0.1 and 100 microns, preferentially between 0.5 and 25 microns;

the constituent forming the thermal ingredient has an internal porosity of less than 20% by volume, preferentially less than 10%, even more preferentially less than 1%;

the thermal ingredient has a volumetric heat capacity of greater than 1200 KJ/m³/K, preferentially greater than 1500 KJ/m³/K and even more preferentially greater than 2000 KJ/m³/K;

the volume ratio of the thermal ingredient to the active ingredient can range from 1/3 up to 1/30, preferably from 1/5 to 1/9;

by weight, the thermal ingredient represents 5% to 90% of the adsorbent mixture, preferably 15% to 50%;

the adsorbent active ingredient is chosen from the group formed by zeolites, activated carbons, activated aluminas, silica gels, resins, carbon-based or non-carbon-based molecular sieves, metalorganic structures, alkali metal or alkaline-earth metal oxides or hydroxides, porous structures containing a substance capable of reversibly reacting with one or more molecules of gas, such as amines, physical solvents, and metal complexing agents, and metal oxides or hydroxides;

the thermal ingredient is taken from the group formed by metals or metal compounds, in particular metal oxides, glass, rocks, porcelains or ceramics.

It will be noted that the two types of microparticles, active ingredient and thermal ingredient, will generally be agglomerated by a binder as is usual practice with standard adsorbents. This binder can represent from approximately 5% to 25% of the volume of the particle, the current trend being to use high performance level binders in a small amount. This binder is not taken into account in the volume ratios of active ingredient and thermal ingredient in the interest of simplification.

The essential point is to obtain a heat transfer between the adsorbent ingredient and the thermal well (inert material, PCM), whatever it is, that is sufficiently rapid so as not to delay the transfer of material. This is a problem known by those working in the laboratory as soon as it is desired to obtain the mass kinetics of an adsorbent by means of a test.

Whether by analysis of the change over time of the pressure curve following an injection of adsorbable constituent into a closed chamber containing the adsorbent or by analysis of the breakthrough curve in a dynamic test, it is difficult to uncorrelate the effects of mass transfer and of heat transfer, that is to say to know whether the curves obtained are only due to the rate of the mass transfer or are partly due to the thermal effects. The use of constituent in trace amounts in a non-adsorbable carrier gas makes it possible to optionally dispense with such a problem, but this situation is then far from the operating conditions of an industrial PSA.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1a illustrates a bed composed of adsorbent particles and inert material particles.

FIG. 1b illustrates a particle comprising an inert core surrounded by an adsorbent layer as known to the art. FIG. 1c illustrates an example where the respective sizes of the particles are unspecified, as known to the art.

FIG. 1d illustrates inert particles of 10 microns combined with adsorbent particles of 30 microns, in accordance with one embodiment of the present invention.

FIG. 2a illustrates a composite adsorbent material with a cross section of a ball, in accordance with one embodiment of the present invention.

FIG. 2b illustrates a composite adsorbent material deposited on a sheet, in accordance with one embodiment of the present invention.

FIG. 2c illustrates a composite adsorbent material in pellet form, in accordance with one embodiment of the present invention.

FIG. 2d illustrates a composite adsorbent material in a ball with an inert core, in accordance with one embodiment of the present invention.

FIG. 3 illustrates monolith produced in accordance with one embodiment of the present invention; and

FIG. 4 illustrates an adsorbent fiber, in accordance with one embodiment of the present invention.

### DESCRIPTION OF PREFERRED EMBODIMENTS

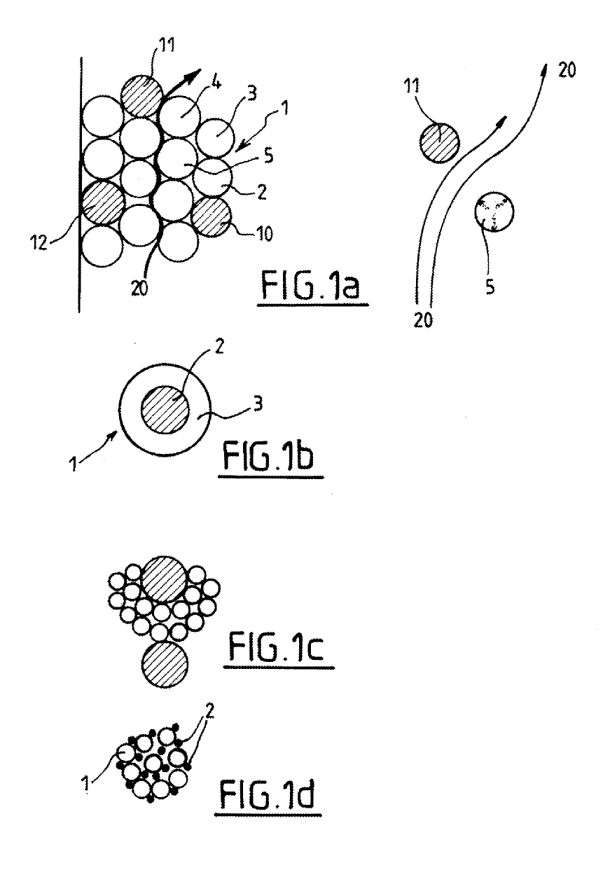

The schemes of FIG. 1 will therefore explain the advantage of the invention.

FIG. 1.a corresponds to a bed 1 composed on the one hand of particles of adsorbent (2, 3, 4, etc.) and of particles of inert material—or of PCM—(10, 11, 12, etc.) mixed in the appropriate proportions, for example 10% by volume of inert material and 90% by volume of adsorbent. The reduction in heating in the adsorption phase is obtained by virtue of the transfer of the adsorption heat released into the particle of adsorbent to the inert material.

In greater detail, the heat released within the particle 5 for example will go to the surface of the particle, essentially by conduction, will pass into the gas 20, will go via convection to the particle inert material 11, will pass to the periphery of 11 and will propagate within this particle. It is obvious that the transfer will depend on the adsorbents and particles used and also on the operating conditions (nature, rate, etc., of the gas) but it can be retained that the two predominant thermal resistances, which may be neighboring, are the diffusion into the particle of adsorbent and the film resistance (transfer to the gas or from the gas to the particle). If the material chosen for the inert material is a good heat conductor, the transfer into the inert material can be substantially faster than the others.

Such a system gives coupling between the transfer of material and the heat transfer and, if the cycle time is shortened by too much, there is benefit from only a part of the potential gains.

FIG. 1.b corresponds to the case envisioned in document FR 2 794 993. The particle 1 comprises an inert core 2 surrounded by an adsorbent layer 3. It is perceived that heat is much faster than in the previous case. The main resistance is the transfer through the adsorbent layer. For a particle 2 mm in diameter having a central core 1 mm in diameter, a layer thickness of 500 microns is obtained. Compared with the previous solution, it can be hoped to gain an order of magnitude.

FIG. 1.c can correspond to one case among others of document U.S. Pat. No. 4,499,208 which does not specify respective sizes to be adhered to for the particles of adsorbent and of inert material, using what is commercially available, that is to say a priori particles of similar size, the particles of inert material 1 possibly being optionally of greater diameter (50 microns for example) than the particles of adsorbent 2 (30 microns for example). Still for 10% by volume of inert material, there will be approximately 50 times fewer microparticles of inert material than microparticles of adsorbent. The heat transfer has again improved compared with the previous case and it is likely that, for PSA cycles that are not too fast, such as those which were used in the 1980s, advantage is then taken of the entire effect linked to the increase in the heat capacity.

FIG. 1.d corresponds to the invention. Inert particles 2 of 10 microns will now be combined with microparticles of adsorbent 1 of 30 microns. Instead of having 50 times fewer particles of inert material, there will now be approximately 3 times more microparticles of adsorbent. On average, each microparticle of adsorbent will have several direct contacts with the thermal ingredient. The thermal path to be taken will correspond only to a fraction of one microparticle of adsorbent. The contact points are multiplied and there is no longer, at least on average, any transfer through several microparticles in series. It can thus be envisioned to take full advantage of the additional heat capacity even for cycles of substantially reduced time.

The thermal ingredient is, as already stated, non-adsorbent, that is to say inert with respect to the adsorption.

The term “inert” means that the constituent does not exhibit any particular affinity for the molecules of the fluid that it is desired to treat by means of this composite material. In practice, it can be said that the adsorption capacity of the thermal ingredient, expressed for example in Ncm³/g, will be less than 5%, or even less than 1% of the adsorption capacity of the adsorbent active ingredient at saturation under the operating conditions and for the constituent to be stopped. It will be seen below that choosing an inert constituent makes it possible to use a non-porous constituent, of high density which is not compatible with the usual constituents of an adsorbent (crystals, binder, etc.).

It will be noted in this respect that the majority of adsorbents used in gas purification or separation processes are, for practical reasons, generally in the form of millimetric particles, balls or rods, formed by agglomeration of adsorbent powder or crystals. This agglomeration often takes place by means of a binder, which is used in proportions of from approximately 5% to 25% by weight. Viewed on the microscopic scale, the usual adsorbents are thus already in the form of a homogeneous composite with an active ingredient and a binder that is essentially inert provided that it has not undergone any transformations which give it a certain adsorption capacity.

One means mentioned for effectively limiting the thermal effects is to use an amount of binder greater than that which is strictly required. In doing so the heat-generating active ingredient within the particle is decreased and the inert part is increased. This modification is not very effective since the binders used are porous, or even very porous, in order to facilitate the transport of material within the particle, and the relative increase in the ratio of the heat capacity to the adsorption heat is due essentially to the decrease in the amount of active adsorbent.

Assuming that a particle has sufficient mechanical properties with only 5% of binder (and 95% of adsorbent), the thermal behavior of this particle is effectively modified by using for example 35% of binder and only 65% of adsorbent. In doing so, it will be possible to increase the ratio of heat capacity to adsorption heat by about forty percent, but also to the detriment of a decrease in adsorption capacity. It is in addition assumed here that the binder has a volumetric heat capacity close to that of the adsorbent, which is generally optimistic.

As opposed to the binder, the thermal ingredient used in the context of the invention will be essentially non-porous (internal porosity less than 20% by volume, preferentially less than 10%, more preferentially porosity close to 0 (that is to say less than 1%)).

It has been previously indicated that the thermal ingredient comprises a volumetric heat capacity (VHC) of greater than 1200 KJ/m³/K, preferentially greater than 1500 KJ/m³/K and more preferentially greater than 2000 KJ/m³/K.

It will be noted that this involves the density of the microparticle itself and not of the powder (collection of microparticles).

For a microparticle that would nevertheless in essence be porous, this porosity is of course taken into account in the basic volume which serves as a reference for determining the VHC, but, as already stated, the particles of the thermal ingredient will preferentially be non-porous, etc.

It will be noted that a value of 1000 to 1200 KJ/m³/K corresponds to the heat capacity of the adsorbent or of the binder estimated on the same bases. Constituents with a volumetric heat capacity that is higher than that of the basic adsorbent will thus, a priori, be chosen.

It has been seen that, in order to be fully effective, the mixture of microparticles of the active ingredient and of the thermal ingredient must be homogeneous in order to ensure the multiple contacts and the very short distances of heat transfer throughout the entire particle.

The term “homogeneous” is intended to mean more specifically herein that the various constituents of the material, such as the adsorbent active ingredient (zeolite crystals, activated carbon powder, resin fragments, etc.), the thermal active ingredient (metal powder, sand, etc.), the binder (kaolin, attapulgite, bentonite, polymer, etc.) or the optional pore-forming agent (sodium cellulose, paraffin, etc.) are intimately mixed during the production of the material, in particular during the forming thereof. As regards several constituents, the mixing in itself can be done in several ways, the constituents being mixed in pairs, altogether, or added one by one in an order chosen to facilitate the operation. This mixing step will essentially depend on the forming process selected. The final product obtained after activation is thus a material in which the active ingredient and the thermal ingredient are evenly distributed throughout it, the local fluctuations in composition being due only to the random nature of the distribution or to the differences in characteristics of the basic materials coupled with the forming process. Such a production process thus differs very clearly from that which consists for example in coating or in covering a thermal ingredient (sand, core, etc.) with an adsorbent material in order to obtain the type of materials described above.

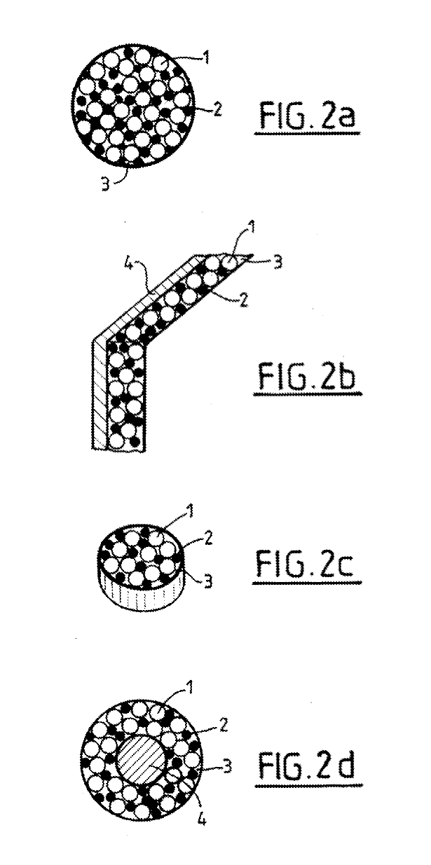

The shape of the final adsorbent product may be a particle—ball, rod, pellet—a sheet, a fiber or a monolith depending on the forming process. For greater clarity, FIG. 2 shows composite adsorbent materials (2.a, b, c, d) which fall within the context of the invention. For all the figures, 1 corresponds to the adsorbent, 2 to the inert material, and 3 corresponds to the binder, to the adhesive or to the polymer used to agglomerate the microparticles. 2.a then corresponds to the section of a ball or of a rod; 2.b corresponds to adsorbent deposited on a sheet 4; 2.c corresponds to a pellet obtained by pressure; 2.d corresponds to a ball comprising an inert core with the aim of increasing the mass kinetics.

The heat capacity of the adsorbent material comprising the inert ingredient will preferentially be at least 20% greater than the heat capacity of the adsorbent of the same volume not comprising this thermal ingredient. It appears that, for such values, substantial gains begin to be attained with regard to the yields (in the case of H₂ and O₂ PSAs).

The thermal ingredient may advantageously be a metal, an alloy, a metal compound, in particular a metal (iron, steel, aluminum, copper, zinc, etc.) oxide, but also quartz, granite, non-porous glass, amorphous granite, porcelain or ceramic, etc.

One very specific case corresponds to a hydrophobic adsorbent material treating a wet gas. The thermal ingredient may then be a hydrophilic adsorbent, such as a zeolite that would be inert with respect to the adsorption given the presence of water, but that would have a high heat capacity precisely because of the trapped water. In this case, the density and the heat capacity to be taken into account will be those of the water-saturated adsorbent that would act with respect to the process as an inert material. Crystals of zeolite 3 A could have this function, the active ingredient then being a hydrophobic adsorbent such as activated carbon or certain silicalites.

The constituent selected as thermal ingredient will preferentially remain solid at the activation temperature or at least the particle will retain sufficient mechanical strength for its shape and its adsorption properties to remain satisfactory for its use in the separation or purification processes. This means that, generally, its melting point is at least 200° C., preferentially greater than 400° C.

Nevertheless, even though it is not greatly industrialized, it is possible to activate a large number of adsorbents at lower temperatures, in particular by applying a vacuum and/or flushing with a very dry gas. This means that, for certain applications, thermal ingredients of PCM type can be used. The microcapsules of PCM will then have to be smaller than the microparticles of adsorbent so as to ensure the desired heat transfer.

As already discussed, the microcrystals of adsorbent and of inert material will generally be agglomerated by means of a binder, an adhesive or a polymer. The binder required for forming the composite material whatever the shape selected can be partly or totally transformed into an adsorbent product by appropriate treatment. This transformation, which makes it possible, inter alia, to obtain adsorbents termed “binder free”, is well known to those skilled in the art and will not be described in greater detail here.

Other ingredients can be added to the paste before forming and activation, such as pore-forming agents which create macroporosities in the particle, thus improving its mass transfer kinetics, pore-protecting agents which prevent clogging or blocking of the pores by the binder, or forming agents which facilitate the forming of the paste.

For the binders, as for the various agents mentioned above, the literature indicates tens of possible constituents, the choice of which will depend on the characteristics of the adsorbent, on the desired shape and on the production processes implemented.

As already specified, the microparticles of the active ingredient and of the thermal ingredient have a diameter (characteristic size) of between 0.10 and 100 microns, preferentially between 0.5 and 25 microns, the microparticles of inert material being smaller in size than those of the adsorbent.

As specified above, for powders generally obtained by milling and microcrystals, the diameter (characteristic size) can be obtained by sieving or by photographic recognition using a microscope. This involves a mean diameter, the populations of microparticles having, a priori, the size dispersions inherent in the processes implemented in order to obtain them (milling, crystallization, etc.). While the 3 dimensions of these microparticles are generally similar, it is not however excluded according to the invention to use a thermal ingredient which is in the form of fibers having a diameter of between 0.1 and 5 microns for example and having a length of from 1 to 100 microns.

The other physical characteristics that come to be required of an adsorbent, such as resistance to attrition, resistance to crushing, kinetics relative to transfer of material, chemical resistance to certain constituents, mechanical strength with respect to temperature variations, etc., can be achieved in the context of the proposed solution by adjusting the quality and the amount of binder, and by choosing the possible adjuvants, the forming process and the upstream or downstream pretreatments (milling, crystallization, drying, surface treatment, activation, etc.). The choice of these parameters is known to those skilled in the art and does not constitute a potential improvement of the principle of the invention. It should, moreover, be noted that the addition of the thermal ingredient can itself modify some of the physical or mechanical characteristics of the particles.

The density, for example, may be substantially higher, making it possible to limit the risks of attrition or of fluidization.

The new material may also have ferromagnetic properties enabling easier separation of the particles (in the case of a mixture or of multibeds) by magnetization or allowing energy to be provided by an electrical effect (in the broad sense: current, waves, etc.).

However, this addition will also be able to reinforce the mechanical strength, the surface finish (decrease in attrition), etc.

A subject of the present invention is also a process for producing an adsorbent mixture according to the invention, comprising the addition of microparticles of the thermal ingredient to the particles of the active ingredient during a step of a process for producing the material comprising the adsorbent active ingredient.

More specifically, the process for producing a material according to the invention consists in adding an inert constituent having a heat capacity of greater than 1200 KJ/m³/K, in the form of microparticles having a mean diameter less than that of the microparticles of adsorbent, during a step of the usual process for producing the adsorbent constituting the active ingredient. Since the thermal ingredient is inexpensive (sand, metal powder, etc.) and its integration into the material very easy and requires only slight modifications to the production line, it is perceived that the increase in costs for such a material with increased heat capacity is virtually negligible.

Contrary to processes which are possibly more efficient, such as the use of phase change materials, for which it is necessary to take into account the increase in costs created, the gains obtained with regard to the purification or separation of the fluids treated using the material according to the invention have no real negative counterpart.

The slight modifications required for the introduction of the thermal ingredient will depend on the process selected for the production of the basic adsorbent constituting the active ingredient of the composite material.

As appropriate, the thermal ingredient is incorporated into the more or less liquid paste containing the microparticles of adsorbent before or during its forming, said forming using for example a die (extruded materials, monoliths, fibers, etc.), a column (balls), a roll mill or a revolving roll system (sheets), an injection nozzle depositing a spray on a support (sheets), a system of brushes depositing a thin layer on a mobile support, a press (pellets, plates) or any other forming process using a liquid or pasty (deformable) mixture, etc.

It will be noted that it may be necessary to modify the amount or the quality of the adjuvants (binder, pore-forming agent, pore-protecting agent, etc.) normally used in order to obtain a satisfactory final product.

The thermal ingredient is injected at the level of the tank nodularizer, alone or premixed with one or more usual constituents (water, gel, binder, pore-forming agent, etc.). This is a conventional process for obtaining balls.

The balls of adsorbent can also be formed in columns, as indicated above, the sufficiently fluid paste being introduced at the level of a perforated plate in the upper part. The “oil drop” method can be attached to this type of process.

The thermal ingredient is injected into the reactor (fluidization tower) used for the growth and the forming of the particles (agglomerate, ball).

Thus, in the case of particles formed in fluidization towers, it will be advisable to just introduce the required flow of inert material so that the latter is deposited evenly with the active ingredient. It may be judicial to choose the size of the microparticles of the thermal ingredient and their density such that they are perfectly fluidized under the normal operating conditions of the fluidization tower. It will be noted that, since they are heavier, the microparticles of inert material will have to be smaller, which clearly falls within the context of the patent.

The paste can also be dried and activated in the form of blocks that will then be ground. Crushed materials are obtained in this way.

Alongside these widely used industrial processes, the forming of adsorbent of newer type, such as a monolith or sheet to which reference was made above, is developing.

Monoliths or sheets are prepared from more or less consistent pastes into which it is possible to integrate a few percent, or even a few tens of percent, of a thermal ingredient before forming (that is to say into the paste itself) or during this forming (for example in a spray onto the sheet simultaneously with the active ingredient).

The thermal ingredient is mixed with the powder of adsorbent and of resin or polymer before pressing in order to obtain pellets or plates.

In addition to the composite adsorbent mixture per se of the processes for forming such a composite material, the invention also relates to the adsorbent formed such as it will be used in an adsorption unit. These will firstly be conventional shapes of adsorbents that are found industrially and have already been mentioned.

As previously mentioned, they may be particles having an essentially spherical shape with a mean diameter ranging from 0.5 to 3 mm or a rod shape with a mean diameter ranging from 0.3 to 3 mm and a mean length having a ratio of 1/1 to 6/1 relative to the diameter. These particles may have an inert central core.

The particles may also be in crushed form essentially cubic in shape with edges having a length ranging on average from 0.5 to 3 mm.

The adsorbent according to the invention may also be in the form of a monolith, having a wall thickness of less than or equal to 4 mm, more preferentially less than 2 mm, for example equal to 1 mm. The monoliths may be of any cross section (square, hexagonal, circular, etc.) and may have a height ranging from a few centimeters to several tens of centimeters. The other characteristics, such as wall thickness, spacing, etc., are not modified by the addition of the thermal ingredient and depend essentially on the production machines. The material according to the invention will be particularly advantageous for rapid mass transfer systems.

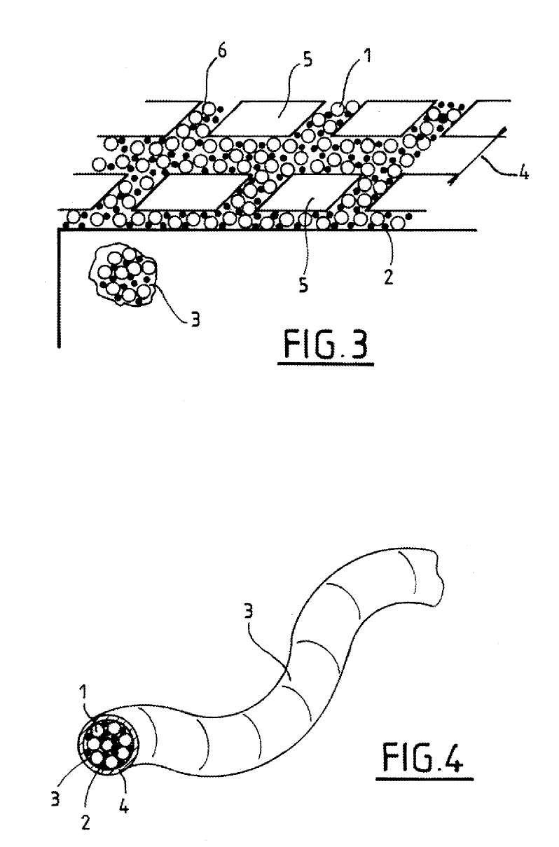

It will be noted that it is assumed here that the majority of the walls comprising the adsorbent material will circulate the fluid on both sides. Given the symmetry, the actual thicknesses to be penetrated by the adsorbable compounds are only half the values indicated above for the walls. A monolith produced according to the invention is represented in FIG. 3, wherein a piece of monolith can be seen with its adsorbent walls 6 and its channels for the passage of the fluids 5. The wall of which the thickness is represented 4 consists of zeolite microcrystals 1 and of microparticles of a constituent that is inert with respect to adsorption 2. The microparticles have not been represented on the walls except in zone 3 in the interest of clarity. Also in this figure, microparticles and wall thickness are not to scale.

It may also be a question of:

a parallel-passage contactor other than a monolith (spool, wheel, stack of sheets, etc.) comprising an adsorbent mixture according to the invention, generally deposited on a support, preferentially in a layer of less than 1 mm, more preferentially in a layer of less than 500 microns, or of

adsorbent fibers having a diameter ranging from 20 microns to 2 millimeters and comprising an adsorbent mixture.

For parallel-passage contactors, reference may be made to document FR 2952553 already cited for greater detail regarding the shapes that it is possible to use.

For the adsorbent fibers, the active ingredient and the thermal ingredient are agglomerated by at least one polymer. The fibers can also undergo a surface treatment, for example the depositing of a layer of a polymer, said layer being about one micron thick, without departing from the context of the invention. It should be noted that the microparticles may be smaller in size than in the case of particulate adsorbent, for example respectively 3 microns for the active ingredient and 1 micron for the thermal ingredient. FIG. 4 represents such an adsorbent fiber 3 with the external layer 4 made of polymer without microparticles and the main cross section 5 with active ingredient 1 and thermal ingredient 2 intimately mixed.

Finally, the present invention relates to an adsorber using a mixture of adsorbent according to the invention and an adsorption unit of PSA H₂, PSA CO₂, PSA O₂, PSA N₂, PSA CO, PSA CH₄ or PSA helium type comprising at least one such adsorber. As already noted, this relates particularly to PSAs with rapid cycle times, that is to say less than or equal to one minute.

The invention will now be described in greater detail from the production of the composite adsorbent to its use in gas separation units.

### EXAMPLES

### Example 1

The first example concerns a PSA H₂ intended for producing ultrapure hydrogen from a syngas containing CO₂ as major impurity. In order to improve the performance levels of the unit, it is desired to limit the thermal effects in the activated carbon bed on which most of the carbon dioxide stops. More specifically, it is desired to increase by at least 25% the volumetric heat capacity of an activated carbon bed intended to stop large amounts of carbon dioxide. The aim is to limit the thermal effects in PSA-type operating mode and overall to increase the performance levels of the adsorption unit.

It will be noted that, with such a modified adsorbent, the situation is far from a perfectly isothermal operation that could be approached by using, as described moreover, composite beds containing notable amounts of PCM particles, but what is sought here is a moderate but nevertheless substantial improvement to the overall process with a very small increase in adsorbent production cost.

By way of example, the targeted gain of 0.5% with regard to the extraction yield of a PSA H₂ of 150 000 Nm³/h corresponds to an annual additional production of more than 7 million Nm³, that is to say the equivalent of the total production of a small unit.

The activated carbons used in these applications are products resulting from the thermal and/or chemical (phosphoric acid, etc.) activation of carbon-based raw materials (wood, pit, shell, coal, peat, etc.). The aim of the activation is to give them a strong porosity and a high adsorbent capacity.

In certain cases, simple crushing of the activated product makes it possible to obtain directly usable particles; in other cases, the final adsorbent is obtained by milling and then agglomeration.

The modified adsorbent according to the invention falls within the context of this second production process.

According to one embodiment, the agglomeration process will then comprise the following steps:

Milling the activated carbon so as to obtain particles of about 1 micron, more specifically of between 0.1 and 50 microns.

Mixing the carbon powder with a liquid agent such as water, an aqueous gel based on clay (bentonite, etc.), an organic gel (pectin, etc.).

Adding quartz in the desired proportions relative to the amount of carbon, in this case approximately 10% by volume.

Mixing with the binder (resin, tar, etc.) with optional heating so as to obtain the mechanical characteristics required for the forming (viscosity, etc.) and optional addition of a forming adjuvant (carboxymethylcellulose, etc.).

Agglomerating, for example by extrusion through a die.

Drying.

It will be noted that there are a large number of processes for producing activated carbon in rod form according to the raw materials and the manufacturers. The description above is obviously not meant to be limiting, but essentially aims to illustrate the simplicity of the modification proposed according to the invention.

The thermal ingredient was added, in the above example, to the pulverulent mixture of carbon powder and liquid agent. It could have been added simultaneously or mixed beforehand with the activated carbon powder. Likewise, the active ingredient can advantageously be mixed beforehand with the binder and can be integrated with said binder into the activated carbon. It can be introduced into the final paste, at the optimal temperature, just before passage through the die. The solution selected will be the one which results, at lower cost, in particles in which active ingredient and thermal ingredient are perfectly distributed while at the same time preserving the required mechanical characteristics.

The optimal amount of inert material can be determined by a simple calculation. The adsorbed capacity at equilibrium is determined by taking into account the increase in temperature resulting from the adsorption. This calculation is done for 100% of adsorbent and for various contents of inert material. The addition of inert material results in two opposite effects. The smaller increase in temperature tends to increase the adsorption capacity, but the decrease in the amount of active ingredient obviously has the opposite effect. An optimum can be found according to the separations envisioned (composition, adsorbent, operating conditions). This approach is often too simplistic and it is generally necessary to take into account the residual amount adsorbed after regeneration which modifies the heat balances. A laboratory test on an actual PSA cycle can be useful for confirming or adjusting the choice of the content of inert material and verifying that the desired gains are indeed obtained.

The size of the quartz particles Di will be determined according to that of the activated carbon Da and of the volume fraction X of inert material. As regards particles of essentially isometric shape that can be likened to spheres or cubes, a size will be determined such that there are at least as many quartz microparticles as there are activated carbon particles.

The following relationship is obtained: Di<(X/(1−X) capacity 1/3)×Da

Since the carbon particles are on average 30 microns, quartz crystals of at most 14 microns will be used. Crystals of 10 microns will thus be perfectly suitable. There will then be many more quartz crystals than carbon microparticles, thus multiplying the contacts for virtually instantaneous heat transfer.

### Example 2

The second example relates to a zeolite intended for the production of oxygen from atmospheric air.

After a first layer intended to stop the moisture and most of the CO₂, the final adsorbent will be an LiLSX and it is assumed here that the basic process for producing this LiLSX consists in first obtaining LSX, forming it into balls 1 mm in diameter, exchanging it with lithium in a column, and then activating it.

The addition of the thermal ingredient is carried out here in the forming step carried out on a revolving plate (or tank nodularizer depending on the technical term used). The balls of selected diameter formed are by accretion, generally around a nucleus facilitating the initiation of the growth of the particle.

Schematically, the usual system comprises a certain number of injection nozzles above the revolving plate. The zeolite crystals, organic additives, binder powder, aerosols of water or of aqueous gel, etc., are thus continuously introduced. Adjustments of the respective flow rates of these products, of the rotational speed of the plate and of the mixer arms that it optionally bears, of the orientation in space of said plate, and of the position of the outlet orifice make it possible to obtain balls of required size, diameter distribution, composition and consistency.

The following steps which will consist in drying the balls and then in optionally modifying the binder by transforming it into zeolite, in exchanging the particles (cation exchange) and then in activating them, are not modified by the addition of the thermal ingredient.

The thermal ingredient, in this case quartz microcrystals, will be injected by addition of supplementary nozzles at the level of the revolving plate.

The addition of 15% by volume of sand results in a substantial increase in the final weight of the particle and the adjustments mentioned previously must be adapted to these new conditions.

It will be noted that the thermal ingredient could be mixed beforehand with the zeolite crystals and injected simultaneously.

The ball thus obtained makes it possible to increase the productivity of the adsorption unit by several percent and to accordingly decrease the specific energy consumption. While the gain is less than what can be obtained using phase change materials, the investment is, for its part, much less. This is particularly true for VSA O₂s with phase times of less than 10 seconds since, as already stated, one of the advantages of the proposed solution is in fact that the scale of the heat transfer is that of the powder or of the crystal, that is to say very much less than that corresponding to the other solutions for reducing the thermal effects for which the scale of the heat transfer is approximately that of the particles: the use of a mixed bed comprising particles of adsorbent and particles of PCM or else the use of balls of adsorbent with an inert core.

According to the invention, heat transfers which are much faster, by at least one order of magnitude, and much more uniform than in the cases mentioned above, are obtained. This effect will become predominant with RPSAs or URPSAs.

For this application, as for others, it may be advantageous to use several different layers comprising adsorbent materials according to the invention but with a different amount of thermal ingredient. The outlet zone of the adsorber which sees only the face of impurities and is therefore subjected only to moderate fluctuations in temperature will only be able to comprise 7.5% of quartz sand by volume. This makes it possible to increase the adsorption capacity of this zone without detriment to the thermal level.

It will be noted that a bed of adsorbent material according to the invention can be used in conjunction with beds of different composition located upstream or downstream. In particular, a bed according to the invention can be used in conjunction with one or more beds comprising phase change materials. For example, in the case of a VSA O₂, it may be advantageous to use on the first 60% to 85% of the zeolite bed a mixture of particles of LiLSX and of PCM and on the remaining 40% to 15% a material according to the invention.

In this case, the latter material is used only in the frontal zone where the thermal kinetics must be particularly fast while the heat fluctuations in themselves are more limited.

It will be noted that the material according to the invention could itself be mixed with particles of adsorbent in order to form a bed of lower heat capacity. This could for example make it possible to use two layers of different heat capacity with modified particles of a single type; for example a first bed of material according to the invention comprising 80% of zeolite and 20% of metal powder and a second bed consisting of 50% of these same particles and 50% of zeolite, the two types of particles being intimately mixed.

It will also be possible to produce an adsorption unit comprising a plurality of parallel-passage contactors, in particular a plurality of monoliths, installed in series, each contactor having a volume fraction of thermal material suitable for its position between inlet and outlet of the adsorber.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1.-15. (canceled)

16. A composite adsorbent mixture of at least one adsorbent active ingredient in the form of microparticles and a non-adsorbent thermal ingredient in the form of microparticles, wherein the characteristic mean size Di of the microparticles of the thermal ingredient is smaller than the characteristic mean size Da of the microparticles of the active ingredient, the composite adsorbent mixture comprising a volume fraction X of thermal ingredient and a fraction (1−X) of active ingredient with X<0.5 and
$$Di < {( \frac{X}{1 - x} )}^{\frac{1}{3}} \times Da ,$$
and the microparticles of the thermal ingredient being greater in number than the microparticles of the active ingredient.

17. The adsorbent mixture of in claim 16, wherein the microparticles of the thermal ingredient have a characteristic mean size of between 0.1 and 100 microns.

18. The adsorbent mixture of claim 16, wherein the constituent forming the thermal ingredient has an internal porosity of less than 20% by volume.

19. The adsorbent mixture of claim 16, wherein the thermal ingredient has a volumetric heat capacity of greater than 1200 KJ/m³/K.

20. The adsorbent mixture of claim 20, wherein the volume ratio of the thermal ingredient to the active ingredient can range from 1/3 to 1/30.

21. The adsorbent mixture of claim 20, wherein, by weight, the thermal ingredient represents 5% to 90% of the adsorbent mixture.

22. The adsorbent mixture of claim 16, wherein the adsorbent active ingredient is chosen from the group consisting of zeolites, activated carbons, activated aluminas, silica gels, resins, carbon-based or non-carbon-based molecular sieves, metalorganic structures, alkali metal or alkaline-earth metal oxides or hydroxides, porous structures containing a substance capable of reversibly reacting with one or more molecules of gas, such as amines, physical solvents, metal complexing agents, and metal oxides or hydroxides.

23. The adsorbent mixture of claim 16, wherein the thermal ingredient is taken from the group consisting of metals or metal compounds, glass, rocks, porcelains or ceramics.

24. Adsorbent particles consisting of an adsorbent mixture as defined in claim 16, having an essentially spherical shape of mean diameter ranging from 0.5 to 3 mm or a rod shape of mean diameter ranging from 0.3 to 3 mm and of mean length having a ratio of from 1/1 to 6/1 relative to the diameter.

25. A monolith comprising an adsorbent mixture as defined in claim 16, having a wall thickness of less than or equal to 4 mm.

26. A parallel-passage contactor comprising, as deposit on a support, an adsorbent mixture as defined in claim 16.

27. Adsorbent fibers having a diameter ranging from 20 microns to 2 millimeters and comprising an adsorbent mixture as defined in claim 16.

28. An adsorber using an adsorbent mixture as defined in claim 16.

29. An adsorption unit of PSA H₂, PSA CO₂, PSA O₂, PSA N₂, PSA CO, PSA CH₄ or PSA helium type comprising at least one adsorber as claimed in claim 28.

30. The adsorption unit as claimed in claim 29 using a cycle time of less than 1 minute.
